(19) United States
(12) Patent Application Publication
(10) Pub. No.: US 2012/0013243 A1
(43) Pub. Date: Jan. 19, 2012

(54) Phosphor composition for AC LEDS and AC LED manufactured with the same

(75) Inventors: Ru-Shi Liu, Shulin City (TW); Chiao-Wen Yeh, Taitung City (TW); Hui-Wen Hsu, Danshui Township (TW); Wen-Hsiung Li, Taichung City (TW); Jung-Chien Chang, Dayuan Township (TW); Yu-Bing Lan, Banqiao City (TW)

(73) Assignee: Forward Electronics Co., Ltd, Taipei City (TW)

(21) Appl. No.: 12/923,180

(22) Filed: Sep. 8, 2010

(30) Foreign Application Priority Data
Jul. 14, 2010 (TW) 099123098

(51) Int. Cl. H01J 1/63; C09K 11/55

(52) U.S. Cl. 313/503; 252/301.4 R

(57) ABSTRACT

The present invention provides a phosphor composition for AC LEDs, which is represented by the following formula (I):

M_{1-x-y}Si₂O_{2-w}N_{2+2w/3}:Euₓ,R_{y} (I)

wherein, M, R, x, y, and w are defined the same as the specification. In addition, the present invention also provides an AC LED manufactured with the same.

### BACKGROUND OF THE INVENTION

1. Field of the Invention

The present invention relates to a phosphor composition for Alternating Current Light Emitting Diodes (AC LEDs) and an AC LED manufactured with the same and, more particularly, to a phosphor composition for AC LEDs that can reduce the scintillation phenomenon of the AC LEDs, and an AC LED manufactured with the same.

2. Description of Related Art

Currently, people in advanced countries use white LEDs as substitutes for traditional illumination devices, due to the awareness of energy saving and environmental protection. The volume of the LEDs is very small, so the LEDs can be applied to devices with small size. The power consumption of LEDs is one eighth or tenth of that of traditional light bulbs, and half of that of fluorescent lamps. In addition, the LEDs also have advantages of long lifetime (>100 thousand hours), low heat emission (low heat radiation), and short reaction time, so they can solve the problems existing in incandescent lamps. Hence, white LEDs are new light sources for 21^{st} century. In addition, LEDs are also referred to as a “green light source” due to their properties of energy saving and environmental protection.

In order to operate DC LEDs with alternating current, a transformer and a rectifier have to be used with LEDs to convert alternating current (AC) to direct current (DC). However, the lifetime of the transformer is about 20 thousand hours generally, but the lifetime of the LEDs is more than 100 thousand hours. Hence, the waste of LEDs due to the expiration of the corresponding transformer causes the increase on the cost. In addition, a lot of heat is generated during the operation of the transformer, and the heat causes the lifetime of the device to decrease and power consumption to increase.

In order to solve the problems resulted from operating DC LEDs with an alternative current, alternating current light emitting diodes (AC LEDs) have been developed. In the AC LEDs, a DC LED chip is cut into many micro-chips to concentrate power on a single chip. Therefore, the transformer can be removed, the heat generation can be decreased, and bidirectional connection can be obtained. In addition, the damage resulting from static electricity can be prevented.

However, conventional AC LEDs have the problem of scintillation and multiple images. FIG. 1 is a perspective view showing the principle for the operation of an AC LED. In general, the operation input voltage of AC LEDs is 80 V, and the frequency is 120 Hz or less. When the voltage is converted, 1/120 sec (10 msec) of time gap, i.e. dead time, is generated. This time gap is highly related to the scintillation phenomenon.

Therefore, it is desirable to provide a phosphor composition for AC LEDs, and the half-life of the phosphor composition can compensate the dead time generated during the voltage conversion to solve the problem of scintillation.

### SUMMARY OF THE INVENTION

The object of the present invention is to provide a phosphor composition for AC LEDs, wherein the dead time of the AC LEDs generated during the voltage conversion can be compensated by the half-life of the phosphor composition.

Another object of the present invention is to provide an AC LED manufactured with the aforementioned phosphor composition. The dead time generated during the voltage conversion can be compensated by the half-life of the phosphor composition, so the scintillation phenomenon of the AC LED can be reduced, and the generation of multiple images can be eliminated.

To achieve the object, the phosphor composition for AC LEDs of the present invention is represented by the following formula (I):

M_{1-x-y}Si₂O_{2-w}N_{2+2w/3}:EUₓ,R_{y} (I)

wherein M is at least one alkaline earth element, and R is a transition metal, or a lanthanide element, 0<x≦1, 0<y<1, and 0≦w<4.

In addition, the present invention also provides an AC LED, which comprises: an LED chip; and a phosphor composition disposed on a light-emitting surface of the LED chip, wherein the phosphor composition is represented by the aforementioned formula (I).

According to the phosphor composition of the present invention, the emission wavelength of the phosphor composition can be controlled by adjusting the N/O ratio. Hence, a phosphor composition, which may emit light in a yellow range to a blue-green range, can be obtained. In addition, the half-life of the phosphor composition of the present invention is in msec scale, so the dead time generated during the voltage conversion can be compensated by the phosphor composition. Furthermore, according to the AC LED manufactured with the phosphor composition of the present invention, the half-life of the phosphor composition compensates for the dead time generated during the voltage conversion, so the scintillation phenomenon of the AC LED can be reduced, and the generation of multiple images can be eliminated.

According to the phosphor composition and the AC LED manufactured with the same of the present invention, M can be at least one selected from the group consisting of Ca, Sr, and Ba. R can be Mn, Ce, or Dy. Preferably, M is at least one selected from the group consisting of Sr, and Ba, and R is Mn.

In addition, according to the phosphor composition the present invention, the phosphor composition has an excitation wavelength of 360-480 nm. Hence, according to the AC LED of the present invention, the LED chip may be a UV-LED chip, or a blue LED chip, in order to excite the phosphor composition of the present invention.

Furthermore, according to the phosphor composition and the AC LED manufactured with the same of the present invention, the phosphor composition has an emission wavelength of 480-600 nm. The emission wavelength can be controlled by adjusting the N/O ratio in the phosphor composition. When w=0, the phosphor composition emits blue-green light. When 0<w≦2, the phosphor composition emits yellow-green light. In addition, when 2<w≦4, the phosphor composition emits yellow light.

According to the phosphor composition and the AC LED manufactured with the same of the present invention, the half-life of the phosphor composition is 1-500 ms.

In addition, the phosphor composition of the present invention can be prepared by a solid-state synthesis. Hence, the process for synthesizing the phosphor composition of the present invention is very simple, and the large-scale production can be achieved easily.

### BRIEF DESCRIPTION OF THE DRAWINGS

FIG. 1 is a perspective view showing the principle for the operation of an AC LED;

FIG. 2 is an excitation spectra of the phosphor compositions of Embodiments 1˜2 and Comparative embodiment of the present invention;

FIG. 3 is an emission spectra of the phosphor compositions of Embodiments 1˜2 and Comparative embodiment of the present invention;

FIG. 4 is a curve showing the half-life of the phosphor composition of Embodiment 1 of the present invention;

FIG. 5 is a curve showing the half-life of the phosphor composition of Embodiment 2 of the present invention;

FIG. 6 is a curve showing the half-life of the phosphor composition of Comparative embodiment of the present invention; and

FIG. 7 is a perspective view of an AC LED of Embodiment 3 of the present invention.

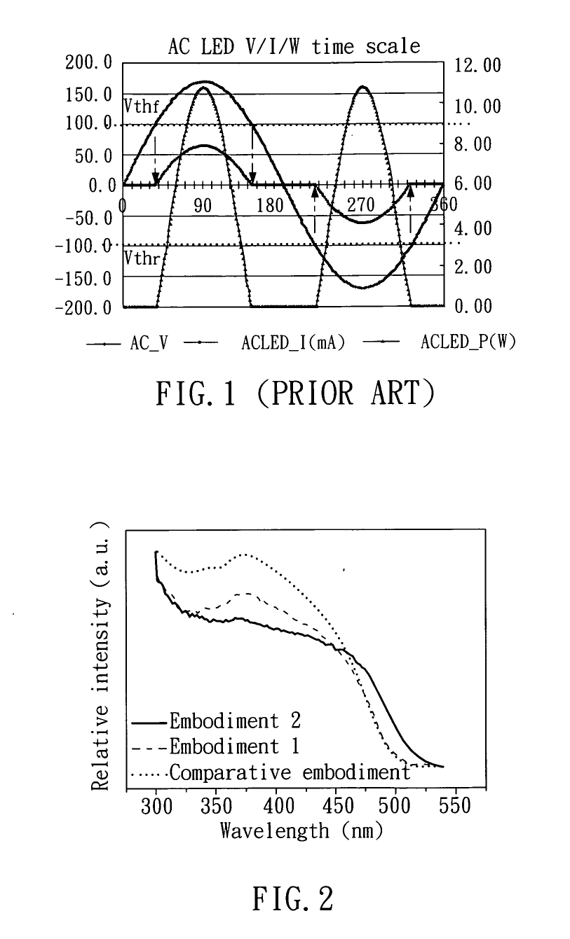

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

Appropriate amount of SrCO₃, Si₃N₄, Eu₂O₃, and MnCO₃ was weighted with stoichiometric ratio to obtain a formula of Sr_{0.88}Si₂O₂N₂:Eu_{0.04}Mn_{0.08}. The powders were mixed and ground in a mortar, and then sintered in 25% H₂-75% N₂ atmosphere at 1500° C. for 1 hr to obtain a light-yellow product. The light-yellow product is the phosphor composition of the present embodiment, i.e. Sr_{0.88}Si₂O₂N₂:Eu_{0.04}Mn_{0.08}.

### Embodiment 2

Appropriate amount of BaCO₃, SrCO₃, Si₃N₄, Eu₂O₃, and MnCO₃ was weighted with stoichiometric ratio to obtain a formula of Sr_{0.46}Ba_{0.46}Si₂O_{1.5}N_{3.5}:Eu_{0.04} Mn_{0.04}. The powders were mixed and ground in a mortar, and then sintered in 10% H₂-90% N₂ atmosphere at 1500° C. for 1 hr to obtain a light-yellow product. The light-yellow product is the phosphor composition of the present embodiment, i.e. Sr_{0.46}Ba_{0.46}Si₂O_{1.5}N_{3.5}:Eu_{0.04}Mn_{0.04}.

### Comparative Embodiment

Appropriate amount of SrCO₃, Si₃N₄, and Eu₂O₃ was weighted with stoichiometric ratio to obtain a formula of Sr_{0.96}Si₂O₂N₂:Eu_{0.04}. The powders were mixed and ground in a mortar, and then sintered in 25% H₂-75% N₂ atmosphere at 1500° C. for 1 hr to obtain a light-yellow product. The light-yellow product is the phosphor composition of the present embodiment, i.e. Sr_{0.96}Si₂O₂N₂:Eu_{0.04}.

### Evaluation of the Emission of the Phosphor Composition

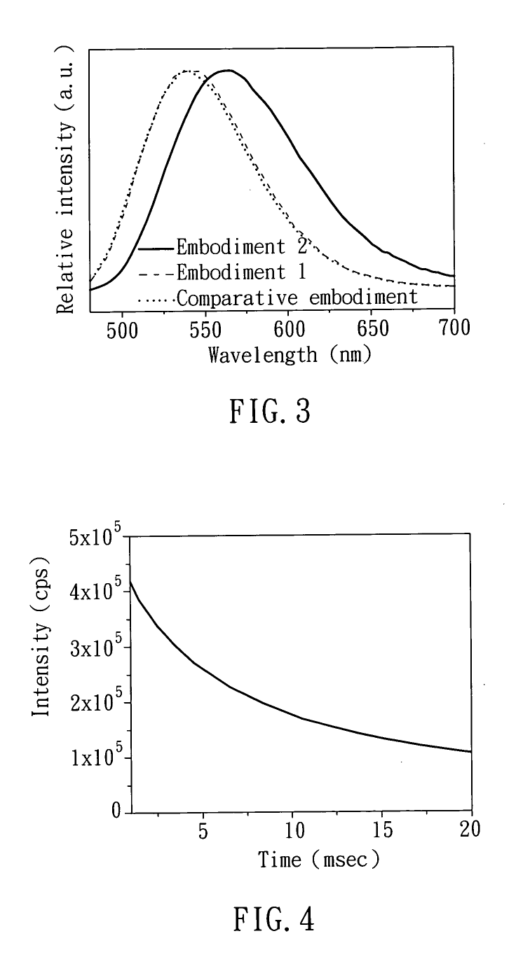

Photoluminescence (PL) spectroscopy was used to analyze the excitation spectra and the emission spectra of the phosphor compositions of Embodiments 1˜2 and Comparative embodiment. The results are shown in FIGS. 2 and 3. FIG. 2 is an excitation spectra of the phosphor compositions of Embodiments 1˜2 and Comparative embodiment, and FIG. 3 is an emission spectra of the phosphor compositions of Embodiments 1˜2 and Comparative embodiment.

As shown in FIG. 2, both of the phosphor compositions of Embodiments 1˜2 can be excited by light with wavelength of 360-480 nm, which indicates that the phosphor compositions of Embodiments 1˜2 can be excited by a UV-LED chip, or a blue LED chip. In addition, as shown in FIG. 3, the phosphor compositions of Embodiment 1 and Comparative embodiment emit blue-green light, and the phosphor composition of Embodiment 2 emits yellow light.

### Evaluation of the Half-Life of the Phosphor Composition

FIG. 4 is a curve showing the half-life of the phosphor composition of Embodiment 1. Light with wavelength of 460 nm was used to excite the phosphor composition to measure the half-life thereof.

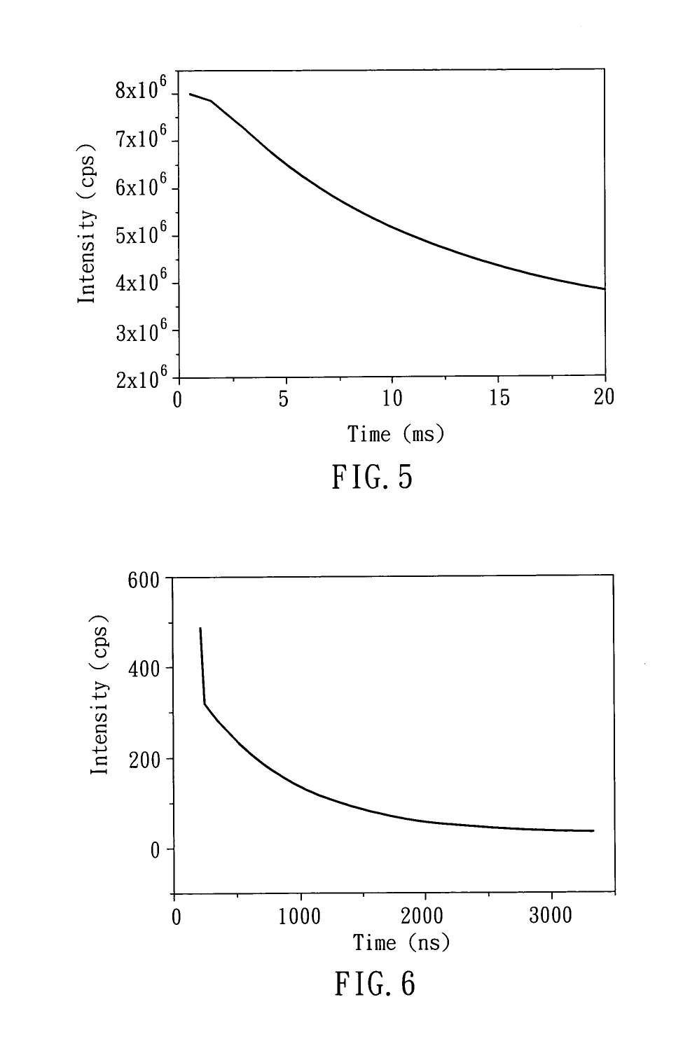

As shown in FIG. 4, the half-life of the phosphor composition of Embodiment 1 is 6.2 msec. In addition, the half-life of the phosphor composition of Embodiment 2 is also in a scale of msec, as shown in FIG. 5. However, the half-life of the phosphor composition of Comparative embodiment is 0.0008 msec, as shown in FIG. 6. Hence, the half-life of the phosphor composition of Embodiment 1 is much longer than that of the phosphor composition of Comparative embodiment. Therefore, the dead time (about 10 msec) generated during the voltage conversion can be compensated by the half-life of the phosphor composition of Embodiments 1-2, so the problems of scintillation and multiple images can be improved.

### Embodiment 3

### Preparation of AC LED

An AC LED manufactured with the phosphor composition of Embodiment 1 is provided.

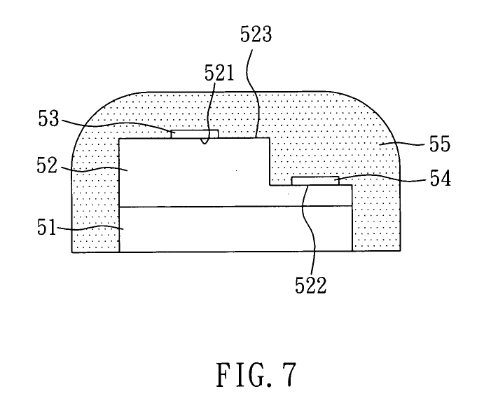

As shown in FIG. 7, the AC LED of the present embodiment comprises: a substrate 51; an epitaxial layer 52 formed on the substrate 51, wherein the epitaxial layer 52 has a first portion 521 and a second portion 522; a first electrode 53 disposed on the first portion 521 of the epitaxial layer 52; a second electrode 54 disposed on the second portion 522 of the epitaxial layer 52; and a transparent encapsulating layer 55 covering the epitaxial layer 52 and the substrate 51, wherein a phosphor composition is contained in the transparent encapsulating layer 55, and light emits from a light-emitting surface 523 of the epitaxial layer 52 to pass through the transparent encapsulating layer 55. Herein, the substrate 51, the epitaxial layer 52, the first electrode 53, and the second electrode 54 are formed as an LED chip. Furthermore, the LED chip can be a UV-LED chip, or a blue LED chip.

In conclusion, the present invention provides a phosphor composition for AC LEDs, which has an adjustable emission wavelength. In addition, the phosphor composition of the present invention is prepared by a solid-state synthesis, so it can be prepared in a simple way and at large-scale. Furthermore, the present invention also provides an AC LED manufactured with this phosphor composition. The half-life of the phosphor composition can compensate the dead time generated during the voltage conversion, so the scintillation phenomenon of the AC LED can be reduced, and the generation of multiple images can be eliminated.

Although the present invention has been explained in relation to its preferred embodiment, it is to be understood that many other possible modifications and variations can be made without departing from the scope of the invention as hereinafter claimed.

What is claimed is:

1. A phosphor composition for AC LEDs, which is represented by the following formula (I):
M_{1-x-y}Si₂O_{2-w}N_{2+2w/3}:Euₓ,R_{y} (I)
wherein M is at least one alkaline earth element, and R is a transition metal, or a lanthanide element, 0<x≦1, 0<y<1, and 0≦w<4.

2. The phosphor composition as claimed in claim 1, wherein M is at least one selected from the group consisting of Ca, Sr, and Ba.

3. The phosphor composition as claimed in claim 1, wherein R is Mn, Ce, or Dy.

4. The phosphor composition as claimed in claim 1, wherein M is at least one selected from the group consisting of Sr, and Ba, and R is Mn.

5. The phosphor composition as claimed in claim 1, wherein the phosphor composition has an excitation wavelength of 360-480 nm.

6. The phosphor composition as claimed in claim 1, wherein the phosphor composition has an emission wavelength of 480-600 nm.

7. The phosphor composition as claimed in claim 1, wherein the half-life of the phosphor composition is 1-500 ms.

8. The phosphor composition as claimed in claim 1, wherein the phosphor composition emits blue-green light, when w=0.

9. The phosphor composition as claimed in claim 1, wherein the phosphor composition emits yellow-green light, when 0<w≦2.

10. The phosphor composition as claimed in claim 1, wherein the phosphor composition emits yellow light, when 2<w≦4.

11. An AC LED, comprising:
an LED chip; and
a phosphor composition disposed on a light-emitting surface of the LED chip, wherein the phosphor composition is represented by the following formula (I):
M_{1-x-y}Si₂O_{2-w}N_{2+2w/3}:Euₓ,R_{y} (I)
wherein M is at least one alkaline earth element, and R is a transition metal, or a lanthanide element, 0<x≦1, 0<y<1, and 0≦w<4.

12. The AC LED as claimed in claim 11, wherein the LED chip is a UV-LED chip, or a blue LED chip.

13. The AC LED as claimed in claim 11, wherein M is at least one selected from the group consisting of Ca, Sr, and Ba.

14. The AC LED as claimed in claim 11, wherein R is Mn, Ce, or Dy.

15. The AC LED as claimed in claim 11, wherein M is at least one selected from the group consisting of Sr, and Ba, and R is Mn.

16. The AC LED as claimed in claim 11, wherein the phosphor composition has an emission wavelength of 480-600 nm.

17. The AC LED as claimed in claim 11, wherein the half-life of the phosphor composition is 1-500 ms.

18. The AC LED as claimed in claim 11, wherein the phosphor composition emits blue-green light, when w=0.

19. The AC LED as claimed in claim 11, wherein the phosphor composition emits yellow-green light, when 0<w≦2.

20. The AC LED as claimed in claim 11, wherein the phosphor composition emits yellow light, when 2<w≦4.
